(19) United States
(12) Patent Application Publication
(10) Pub. No.: US 2020/0358045 A1
(43) Pub. Date: Nov. 12, 2020

(54) NONAQUEOUS ELECTROLYTE SECONDARY BATTERY

(71) Applicant: TDK CORPORATION, Tokyo (JP)

(72) Inventors: Takamasa MINAMI, Tokyo (JP); Hideaki SEKI, Tokyo (JP)

(73) Assignee: TDK CORPORATION, Tokyo (JP)

(21) Appl. No.: 16/642,117

(22) PCT Filed: Feb. 1, 2019
(86) PCT No.: PCT/JP2019/003683

§ 371 Date: Feb. 26, 2020

(30) Foreign Application Priority Data
Feb. 2, 2018 (JP) 2018-017616

(51) Int. Cl. H01M 2/04; H01M 2/30; H01M 10/0569; H01M 10/058; H01M 10/0525

(52) U.S. Cl. CPC H01M 2/04; H01M 2/30; H01M 10/0525; H01M 10/058; H01M 10/0569

(57) ABSTRACT

The nonaqueous electrolyte secondary battery includes a power generation element in which a positive electrode and a negative electrode exchange ions via an electrolyte, two terminals connected to the positive electrode and the negative electrode, respectively, and an exterior body which is formed by extending one terminal of each of the outer sides to cover the power generation element and the two terminals, and the outer circumference of which is sealed. A seal strength of the outer periphery of the exterior body is the weakest at a terminal sealing portion sandwiching the two terminals; and at least one surface of the terminal seal portion has a seal strength of 4.5 N/mm or less.

### TECHNICAL FIELD

The present invention relates to a nonaqueous electrolyte secondary battery.

The present application claims priority based on Japanese Patent Application No. 2018-017616 filed on Feb. 2, 2018, the contents of which are incorporated herein by reference.

### BACKGROUND ART

For the purpose of reducing the weight of the battery and increasing the degree of freedom in battery design, a laminated cell using a laminated film obtained by laminating a metal foil and a resin as an exterior body has been put to practical use. In such a battery, when gas is generated due to overcharge or the like and the internal pressure of the battery increases, the laminate film expands significantly. When the space between the power generation element and the laminate film is filled with gas due to expansion, the power generation element is insulated from the outside air by the gas, and the reaction heat generated by overcharging is stored in the power generation element, and further abnormal reaction is accelerated. When such a problem occurs, the power generation element is damaged, and the battery pack is deformed and the electronic device is damaged.

Patent Documents 1 and 2 describe nonaqueous electrolyte secondary batteries in which the sealing performance of a part of the sealing portion of the laminate cell is reduced. By intentionally reducing the strength of some of the seals, gas is selectively exhausted from those areas and bursting of the laminate cell is avoided.

[Patent Document 1] Japanese Unexamined Patent Application Publication No. 1999-86823

[Patent Document 2] Japanese Unexamined Patent Application Publication No. 2008-91240

### SUMMARY OF THE INVENTION

However, in the nonaqueous electrolyte secondary battery described in Patent Documents 1 and 2, although the direction in which gas is discharged can be controlled, the timing and ease of gas discharge are not considered.

If the gas is not discharged or the gas discharge is slow, the rise in temperature of the power generation element cannot be suppressed, and the further abnormal reaction is accelerated. That is, in order to suppress the temperature rise of the power generation element, it is important not only to discharge the gas at an appropriate timing but also to quickly discharge the generated gas to the outside of the battery system. It is considered that the temperature rise of the power generation element can be suppressed by cooling the power generation element by eliminating the difference between the gas pressure inside the battery and the outside air pressure, and making circulation of the inside and outside air of the battery through a discharge port.

The present invention has been made in view of the above problems, and an object of the present invention is to provide a nonaqueous electrolyte secondary battery capable of rapidly reducing the internal pressure before abnormal heat generation occurs during overcharge.

The present inventors have conducted intensive studies and found that, it is possible to suppress the power generation element from generating abnormal heat, by setting the seal strength of the exterior body to a predetermined value and setting the place where the exterior body is to be broken at a predetermined position.

That is, the following means are provided to solve the above problems.

(1) The nonaqueous electrolyte secondary battery according to a first aspect, including a power generation element in which a positive electrode and a negative electrode exchange ions via an electrolyte; two terminals connected to the positive electrode and the negative electrode, respectively; and an exterior body which covers the power generation element and the two terminals so that one end of each of the two terminals extends outward, and which has a sealed outer periphery, wherein a seal strength of the outer periphery of the exterior body is the weakest at a terminal sealing portion sandwiching the two terminals, and at least one surface of the terminal seal portion has a seal strength of 4.5 N/mm or less.

(2) In the nonaqueous electrolyte secondary battery according to the above aspect, a distance between an inner end portion of the terminal seal portion and the power generation element is 1.2 mm or more and 15 mm or less.

(3) The nonaqueous electrolyte secondary battery according to the above aspect further comprising an insulation tape connecting at least one of the two terminals and an outermost surface of the power generation element.

(4) In the nonaqueous electrolyte secondary battery according to the above aspect, the exterior body has a first surface and a second surface that intersect with a line perpendicular to a surface extending from the sealing surface, and a seal strength of the terminal seal portion on the first surface side is the weakest among seal strengths of the outer periphery of the exterior body.

(5) In the nonaqueous electrolyte secondary battery according to the above aspect, the exterior body is formed by sealing exterior films each having a metal layer inside, and a thickness of the metal layer in the terminal seal portion on the first surface side is smaller than a thickness of the metal layer in the terminal seal portion on the second surface side.

(6) In the nonaqueous electrolyte secondary battery according to the above aspect, the electrolyte contained in the power generation element comprises a salt and a nonaqueous solvent, and the nonaqueous solvent comprises 50% or more by mass and 85% or less by mass of a low-boiling solvent having a boiling point of 130° C. or less.

(7) In the nonaqueous electrolyte secondary battery according to the above aspect, the electrolyte contained in the power generation element comprises a salt and a nonaqueous solvent, and the nonaqueous solvent comprises 35% or more by mass and 85% or less by mass of a low-boiling solvent having a boiling point of 110° C. or less.

The internal pressure of the nonaqueous electrolyte secondary battery according to the above aspect can be reduced before abnormal heat generation occurs during overcharge.

### BRIEF DESCRIPTION OF DRAWINGS

FIG. 1 is a schematic view of an example of a nonaqueous electrolyte secondary battery according to the present embodiment.

FIG. 2 is a schematic cross-sectional view of an example of a nonaqueous electrolyte secondary battery according to the present embodiment.

FIG. 3 is a schematic plan view of an example of a nonaqueous electrolyte secondary battery according to the present embodiment.

### DETAIL DESCRIPTION OF THE INVENTION

Hereinafter, preferred examples of the present embodiment will be described in detail with reference to the drawings. The drawings used in the following description may be enlarged to show the features of the present invention for the sake of convenience, and the dimensional ratio of each component may be different from the actual one. The materials, dimensions, and the like exemplified in the following description are only examples, and the present invention is not limited to them, but may be modified as appropriate without changing the gist thereof. In other words, the present invention is not limited to the following embodiments, but can be modified as appropriate to achieve the effects. For example, numbers, numerical values, quantities, ratios, shapes, positions, and characteristics can be omitted, added, or changed without departing from the gist of the present invention.

[Nonaqueous Electrolyte Secondary Battery]

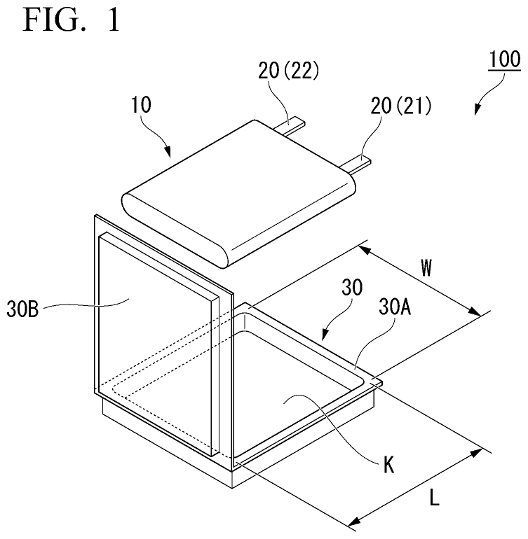

FIG. 1 is a schematic view schematically showing an example of the nonaqueous electrolyte secondary battery according to the present embodiment. The nonaqueous electrolyte secondary battery 100 shown in FIG. 1 includes a power generation element 10, two terminals 20 (a positive electrode terminal 21 and a negative electrode terminal 22), and an exterior body 30. The power generation element 10 is housed in a housing space K provided in the exterior body 30. In FIG. 1, for ease of understanding, a state immediately before the power generation element 10 is housed in the exterior body 30 is illustrated. Hereinafter, the direction in which the terminal 20 extends from the power generation element 10 is referred to as x direction, the direction orthogonal to the x direction in the plane in which the terminal 20 extends is referred to as y direction, and the direction orthogonal to both the x direction and the y direction is referred to as z direction.

(Power Generation Element)

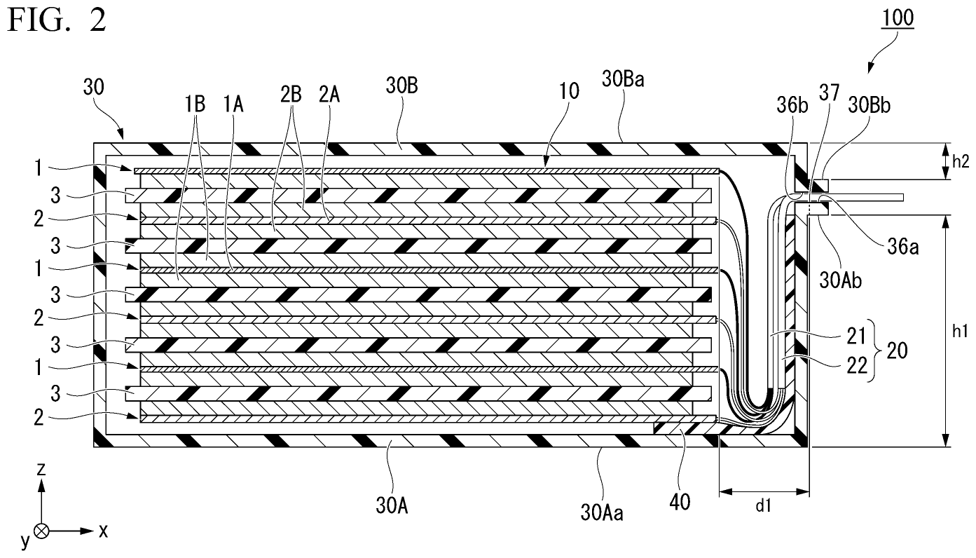

FIG. 2 is a schematic cross-sectional view schematically showing a cross section of an example of the nonaqueous electrolyte secondary battery according to the present embodiment. The power generation element 10 shown in FIG. 2 has a positive electrode 1, a negative electrode 2, and a separator 3. The power generation element 10 illustrated in FIG. 2 is a laminate in which the positive electrode 1 and the negative electrode 2 are arranged to face each other with the separator 3 interposed therebetween. The power generation element 10 may be a wound body formed by winding a laminate in which the positive electrode 1 and the negative electrode 2 are arranged to face each other with the separator 3 interposed therebetween.

The positive electrode 1 has a plate-shaped (film-shaped) positive electrode current collector 1A and a positive electrode active material layer 1B. The positive electrode active material layer 1B is formed on at least one surface of the positive electrode current collector 1A. The negative electrode 2 has a plate-shaped (film-shaped) negative electrode current collector 2A and a negative electrode active material layer 2B. The negative electrode active material layer 2B is formed on at least one surface of the negative electrode current collector 2A. The positive electrode active material layer 1B and the negative electrode active material layer 2B are impregnated with an electrolyte. The positive electrode 1 and the negative electrode 2 exchange ions through the electrolyte.

The positive electrode current collector 1A may be a conductive plate material, and for example, a thin metal plate of aluminum, stainless steel, copper, or nickel foil can be used.

As the positive electrode active material used for the positive electrode active material layer 1B, an electrode active material capable of reversibly proceeding occlusion and release of ions, desorption and insertion of ions (intercalation), or doping and de-doping of ions and counter anions can be used. As the ion, for example, a lithium ion, a sodium ion, a magnesium ion and the like can be used, and it is particularly preferable to use the lithium ion.

For example, in the case of a lithium ion secondary battery, although not limited to these examples, a composite metal oxide such as a lithium cobalt oxide (LiCoO₂), a lithium nickel oxide (LiNiO₂), a lithium manganate (LiMnO₂), a lithium manganese spinel (LiMn₂O₄), a composite metal oxide represented by general formula: LiNiₓCo_{y}Mn_{z}MₐO₂ (x+y+z+a=1, 0≤x<1, 0≤y<1, 0≤z<1, 0≤a<1, M is one or more elements selected from Al, Mg, Nb, Ti, Cu, Zn, Cr), a lithium vanadium compound (LiV₂O₅), an olivine type LiMPO₄ (where M is one or more elements selected from the group consisting of Co, Ni, Mn, Fe, Mg, Nb, Ti, Al, Zr; or VO), a lithium titanate (Li₄Ti₅O₁₂), LiNiₓCo_{y}AlO₂(0.9<x+y+z<1.1); a polyacetylene; a polyaniline; a polypyrrole; a polythiophene; a polyacene and the like can be preferably used.

Moreover, the positive electrode active material layer 1B may further have a conductive material. Examples of the conductive material include, but are not limited to, carbon powders such as carbon blacks, carbon nanotubes, carbon materials; metal fine powders such as copper, nickel, stainless steel, and iron; mixtures of carbon materials and metal fine powders; conductive oxides such as ITO. When sufficient conductivity can be ensured only by the positive electrode active material, the positive electrode active material layer 1B may not include a conductive material.

The positive electrode active material layer 1B may include a binder. Known binders can be used. For example, a fluorinated resin such as polyvinylidene fluoride (PVDF), polytetrafluoroethylene (FTFE), tetrafluoroethylene-hexafluoropropylene copolymer (FEP), tetrafluoroethylene-perfluoroalkylvinyl ether copolymer (PFA), ethylene-tetrafluoro ethylene copolymer (ETFE), polychlorotrifluoroethylene (PCTFE), ethylene-chlorotrifluoroethylene copolymer (ECTFE), and polyvinyl fluoride (PVF) may be used as the binder.

In addition to the above, as the binder, for example, vinylidene fluoride-based fluororubbers such as vinylidene fluoride-hexafluoropropylene-based fluororubber (VDF-HFP fluororubber), vinylidene fluoride-hexafluoropropylene-tetrafluoroethylene-based fluororubber (VDF-HFP-TFE fluororubber), vinylidene fluoride-pentafluoropropylene fluororubber (VDF-PFP fluororubber), vinylidene fluoride-pentafluoropropylene-tetrafluoroethylene fluororubber (VDF-PFP-TFE fluororubber), vinylidene fluoride-perfluoromethyl vinyl ether-tetrafluoroethylene fluororubber (VDF-PFMVE-TFE fluororubber), vinylidene fluoride-chlorotrifluoroethylene fluororubber (VDF-CTFE-fluororubber) may be used.

The negative electrode active material used for the negative electrode active material layer 2B may be any compound that can occlude and release ions, and a known negative electrode active material used for a nonaqueous electrolyte secondary battery can be used. Examples of the negative electrode active material include alkali metals such as lithium metal; alkaline earth metals; carbon materials such as graphite capable of occluding and releasing ions (natural graphite, artificial graphite), carbon nanotubes, non-graphitizable carbon, easily graphitizable carbon, and low-temperature calcined carbon; metals that can be combined with metals such as lithium, aluminum, silicon and tin; amorphous compounds mainly consisting of oxides such as SiOₓ (0<x<2) and tin dioxide; and particles containing lithium titanate (Li₄Ti₅O₁₂).

The negative electrode current collector 2A, the conductive material, and the binder of the negative electrode 2 may be the same as the positive electrode current collector 1A, the conductive material, and the binder of the positive electrode 1, respectively.

In addition to the binder used for the positive electrode, for example, cellulose, styrene-butadiene rubber, ethylene-propylene rubber, polyimide resin, polyamideimide resin, acrylic resin, and the like may be used for the negative electrode.

The separator 3 may be formed of an electrically insulating porous structure. As the separator 3, for example, a monolayer of a film made of a polyolefin such as polyethylene or polypropylene, a laminate thereof, and a stretched film of a mixture of the above resins; or a fibrous nonwoven fabric made of at least one kind of constituent materials selected from the group consisting of cellulose, polyester, polyacrylonitrile, polyamide, polyethylene, and polypropylene, may be used.

From the viewpoint of suppressing the temperature rise of the power generation element 10, the separator 3 preferably has a layer mainly containing inorganic particles laminated on at least one surface thereof. The layer mainly containing inorganic particles has high liquid retention and air permeability. Therefore, when the temperature of the power generation element 10 rises, the electrolyte retained in the inorganic particle layer is easily vaporized, and the temperature rise of the power generation element 10 can be relaxed by the vaporization heat at that time. The thickness of the inorganic particle layer is preferably 1.5 μm or more. Also, from the viewpoint of energy density, the thickness of the inorganic particle layer is preferably 4.0 μm or less. Examples of the inorganic particles include particles containing oxides such as alumina, silica and zirconia; hydroxides such as boehmite and magnesium hydroxide; or carbonates such as lithium carbonate and calcium carbonate.

Regardless of whether the power generation element 10 is a laminate or a wound body, it is preferable to dispose the positive electrode current collector 1A on the outermost layer side of the power generation element 10. Since the temperature of the positive electrode 1 is likely to become high during overcharge, the power generation element 10 can be efficiently cooled by disposing the positive electrode current collector 1A on the outermost layer side of the power generation element 10. The outermost layer of the power generation element 10 is not limited to the positive electrode current collector 1A, but may be the negative electrode current collector 2A or the separator 3.

As the electrolyte, for example, an electrolyte solution containing a salt or the like (aqueous electrolyte solution, nonaqueous electrolyte solution) can be used. The aqueous electrolyte solution has a low electrochemical decomposition voltage and a low withstand voltage during charging. Therefore, it is preferable to use a nonaqueous electrolyte as the electrolyte. The nonaqueous electrolyte uses a nonaqueous solvent such as an organic solvent as a solvent.

Nonaqueous electrolyte contains salt (electrolyte) and a nonaqueous solvent. The nonaqueous solvent may contain a cyclic carbonate and a chain carbonate. The ratio of the cyclic carbonate to the chain carbonate in the nonaqueous solvent is preferably from 1:9 to 1:1 by volume.

As the cyclic carbonate, those capable of solvating the electrolyte are used. For example, ethylene carbonate, propylene carbonate, butylene carbonate and the like are used as the cyclic carbonate.

The chained carbonate reduces the viscosity of the cyclic carbonate. For example, diethyl carbonate, dimethyl carbonate, ethyl methyl carbonate or the like are used as the chained carbonate. In addition, chain esters such as methyl acetate, ethyl acetate, methyl propionate, and ethyl propionate; cyclic esters such as γ-butyrolactone; nitriles such as acetonitrile, propionitrile, glutaronitrile, and adiponitrile; 1,2-Dimethoxyethane; 1,2-diethoxyethane and the like may be used after mixing them.

The nonaqueous solvent preferably contains 50% or more by mass and 85% or less by mass of a low-boiling solvent having a boiling point of 130° C. or less, more preferably 60% or more by mass and 85% or less by mass of the same, and still more preferably from 70% and more by mass and 85% or less by mass of the same. Further, the nonaqueous solvent preferably contains of 35% or more by mass and 85% or less by mass of a low boiling point solvent having a boiling point of 110° C. or less, more preferably 45% or more by mass and 85% or less by mass, and still more preferably 55% or more by mass and 85% or less by mass.

When the nonaqueous solvent contains a low-boiling solvent having a low boiling point, the amount of gas discharged from the exterior body 30 when the exterior body 30 is broken can be increased. When the amount of exhaust gas increases, the cooling effect by the latent heat of evaporation is promoted. That is, the power generation element 10 is cooled by the exhaust gas, and as a result, the generation of abnormal heat by the power generation element 10 can be suppressed.

A metal salt can be used as the electrolyte. For example, a lithium salt such as LiPF₆, LiClO₄, LiBF₄, LiCF₃SO₃, LiCF₃CF₂SO₃, LiC(CF₃SO₂)₃, LiN(CF₃SO₂)₂, LiN(CF₃CF₂SO₂)₂, LiN(CF₃SO₂)(C₄F₉SO₂), LiN(CF₃CF₂CO)₂, LiBOB, or the like may be used. In addition, one or more of these lithium salts may be used alone or in combination. In particular, from the viewpoint of the degree of ionization, it is preferable to include LiPF₆ as the electrolyte.

When dissolving LiPF₆ in a nonaqueous solvent, the concentration of the electrolyte in the nonaqueous electrolyte is preferably adjusted to 0.5 to 2.0 mol/L. When the concentration of the electrolyte is 0.5 mol/L or more, the lithium ion concentration of the nonaqueous electrolyte can be sufficiently ensured, and a sufficient capacity can be easily obtained during charge and discharge. In addition, by suppressing the concentration of the electrolyte within 2.0 mol/L, the increase in the viscosity of the nonaqueous electrolyte can be suppressed, and therefore, the mobility of lithium ions can be sufficiently secured. And as a result, it becomes easy to obtain the sufficient capacity during charge and discharge.

When LiPF₆ is mixed with another electrolyte, it is preferable to adjust the concentration of all lithium ions in the nonaqueous electrolyte to 0.5 to 2.0 mol/L, and more preferably, the concentration of lithium ions from LiPF₆ is 50 mol % or more.

The nonaqueous electrolyte may be a gel electrolyte held by a polymer material. Examples of the polymer material include polyvinylidene fluorides and copolymers of polyvinylidene fluorides. Examples of the copolymer monomers used as the polymer material include hexafluoropropylene and tetrafluoroethylene. These polyvinylidene fluorides and copolymers thereof are preferable because excellent battery characteristics can be obtained.

As the polymer material, for example, a polyacrylonitrile and a copolymer of a polyacrylonitrile can also be used. Examples of the copolymer monomer used as the polymer material include vinyl acetate, methyl methacrylate, butyl methacrylate, methyl acrylate, butyl acrylate, itaconic acid, hydrogenated methyl acrylate, hydrogenated ethyl acrylate, acrylamide, vinyl chloride, vinylidene fluoride or vinylidene chloride and like as a vinyl monomer. In addition, acrylonitrile butadiene rubber, acrylonitrile butadiene styrene resin, acrylonitrile chloride polyethylene propylene diene styrene resin, acrylonitrile chloride polyethylene propylene diene styrene resin, acrylonitrile vinyl chloride resin, acrylonitrile methacrylate resin or acrylonitrile acrylate resin, and the like may be used.

Further, as the polymer material, for example, a polyethylene oxide and a copolymer of polyethylene oxide may be used. Examples of the copolymer monomer used as a polymer material include polypropylene oxide, methyl methacrylate, butyl methacrylate, methyl acrylate or butyl acrylate, and the like. Alternatively, a polyether-modified siloxane and a copolymer thereof may be used.

(Terminal)

There are two terminals 20, one is a positive electrode terminal 21 and the other is a negative electrode terminal 22. One end (inner end) of the terminal 20 is connected to the power generation element 10, and the other end (outer end) extends outside the exterior body 30. The two terminals 20 may each extend in the same direction, or may extend in different directions. The positive electrode terminal 21 is connected to the positive electrode current collector 1A, and the negative electrode terminal 22 is connected to the negative electrode current collector 2A. The connection method is not particularly limited, and welding, screwing, or the like can be used. A conductive material such as aluminum or nickel can be used for the terminal 20. A resin film made of polypropylene, nylon, or the like may be previously adhered to the terminal 20 at a position corresponding to a terminal seal portion 36. The resin film may be a single layer or a multilayer.

(Exterior Body)

The exterior body 30 seals the power generation element 10 and the electrolyte inside. For the exterior body 30, for example, a metal laminate film in which a metal foil is coated with a polymer film from both sides can be used. As the metal foil, for example, an aluminum foil can be used. As the polymer film, a film such as polypropylene can be used. For example, a polymer having a high melting point, such as polyethylene terephthalate (PET) and polyamide, is preferable as a material of the outer polymer film. Polyethylene (PE) and polypropylene (PP) are preferable as a material of the inner polymer film.

In the exterior body 30 shown in FIG. 1, a first surface 30A and a second surface 30B are folded to constitute a housing space K. The first surface 30A and the second surface 30B are closely adhered by sealing the outer periphery. The exterior body 30 is not limited to one in which the first surface 30A and the second surface 30B are folded to form the housing space K as shown in FIG. 1, and may be one in which two films are joined. A recess may be provided in each of the two films, or may be provided in only one of the films.

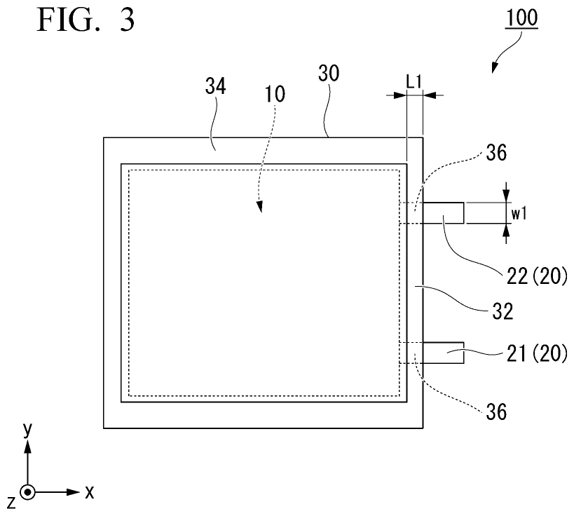

FIG. 3 is a schematic plan view of the nonaqueous electrolyte secondary battery 100 according to the present embodiment. As shown in FIG. 3, the outer periphery of the exterior body 30 has a top seal portion 32, a side seal portion 34, and a terminal seal portion 36.

The top seal portion 32 is a portion where two parts of the exterior body 30 are in close contact with each other on the side where the terminals 20 extend. The side seal portion 34 is a portion where two parts of the exterior body 30 are in close contact with each other in a direction intersecting the side where the terminal 20 extends. The terminal seal portion 36 is a portion where the terminal 20 and the exterior body 30 are in close contact with each other. In FIG. 3, there are four surfaces in terminal seal portion 36. Specifically, the four surfaces include a surface where the positive electrode terminal 21 and the first surface 30A of the exterior body 30 are in close contact, a surface where the positive electrode terminal 21 and the second surface 30B of the exterior body 30 are in close contact, a surface where the negative electrode terminal 22 and the first surface 30A of the exterior body 30 are in close contact, and a surface where the negative electrode terminal 22 and the second surface 30B of the exterior body 30 are in close contact.

The seal strength of the exterior body 30 is the weakest in the terminal seal portion 36. Here, the weakest in the terminal seal portion 36 means that the seal strength on any one of the four parts forming the terminal seal portion 36 is the weakest. That is, if the seal strength of any one of the surfaces is the weakest, the seal strength of the other parts may be stronger than the other sealing portions.

When the seal strength of the terminal seal portion 36 is weaker than other portions, the terminal seal portion 36 is selectively broken when the internal pressure of the battery increases. As shown in FIG. 2, in the exterior body 30, a space exists between the power generation element 10 and the terminal 20 on the terminal 20 side, in order to draw out the terminal 20. When the terminal seal portion 36 is broken, the gas is discharged from the broken portion through this space, so that the pressure loss in the gas flow path is small and the gas is quickly discharged. After the gas is discharged, the internal gas is exchanged with the outside air through the gas flow path. Since the gas flow path has a small pressure loss, the gas inside can be quickly exchanged with outside air, and the cooling efficiency of the power generation element 10 can be enhanced.

The distance d1 between the inner end portion 37 of the terminal seal portion 36 and the power generation element 10 is preferably 1.2 mm or more and 15 mm or less, more preferably 1.5 mm or more and 10 mm or less, and still more preferably 2.0 mm or more and 5.0 mm or less. Here, the inner end portion 37 of the terminal seal portion 36 means an end portion on the power generation element 10 side of a contact surface (adhesive surface) on which the terminal 20 and the exterior body 30 are in close contact with each other. If the distance d1 is within this range, a sufficient space can be secured between the power generation element 10 and the terminal 20. On the other hand, this space that does not contribute to power generation can be prevented from becoming too wide.

The seal strength of the surface having the weakest seal strength among the four surfaces of the terminal sealing portion 36 is 4.5 N/mm or less, more preferably 3.6 N/mm or less, and still more preferably 3.0 N/mm or less. Further, the seal strength of each surface of the terminal seal portion 36 is preferably 4.5 N/mm or less, more preferably 3.6 N/mm or less, and still more preferably 3.0 N/mm or less. Here, the seal strength means a seal strength at room temperature (25° C.). The temperature of the exterior body 30 when the exterior body 30 is broken is higher than room temperature. However, the seal strength can actually be measured at room temperature, and there is a correlation between the seal strength at room temperature and the seal strength at a temperature higher than room temperature.

The seal strength is measured using a constant-speed extension type tensile tester. In order to measure the seal strength, first, a test piece is prepared. When determining the seal strength of the top seal portion 32 and the side seal portion 34, a test piece cut out to a width of 6 mm and set to a developed length of 40 mm is used. When determining the seal strength of the terminal seal portion 36, a test piece having a seal portion between the exterior body 30 and the terminal 20 cut out to a width of 6 mm and a developed length of 40 mm is used. When the width of the terminal 20 is less than 6 mm, the width of the exterior body 30 is also adjusted to the width of the terminal 20. Then, the test piece is opened at 180° with the sealed portion as the center, and is supported at two points. The distance between the two supporting points is 15 mm. The two supporting points are pulled in opposite directions (180° direction) at a speed of 100 mm/min, and a tensile load is applied. Then, the seal load is obtained by dividing the maximum load (N) when the seal portion is broken by the width.

When the seal strength of the terminal seal portion 36 is 4.5 N/mm or less, the terminal seal portion 36 is broken when the internal pressure of the exterior body 30 exceeds a predetermined value. The internal pressure of the exterior body 30 is correlated with the temperature of the power generation element 10. That is, it is possible to prevent the power generation element 10 from generating abnormal heat by breaking the exterior body 30 when the internal pressure reaches a predetermined level.

It is preferable that the first sealing surface 36a on the first surface 30A side of the exterior body 30 (see FIG. 2) has the weakest seal strength of the terminal seal portion 36. The first sealing surface 36a may be either a sealing surface with the positive electrode terminal 21 or a sealing surface with the negative electrode terminal 22. The first surface 30 A is a surface on the far side of distances h1, h2 with the terminal seal portion 36 out of two surfaces (first surface 30 A, second surface 30 B) located at a position crossing a line segment perpendicular to a surface extending from the sealing surface of the exterior body 30. Here, the distance h1 corresponds to the length of a perpendicular line extending from the outer surface 30 Aa of the first surface 30A to the outer surface 30Ab of the first surface 30A side of the exterior body 30 covering the terminal seal portion 36. Further, the distance h2 corresponds to the length of a perpendicular extending from the outer surface 30Ba of the second surface 30B to the outer surface 30Bb of the second surface 30B side of the exterior body 30 covering the terminal seal portion 36.

When the distance h1 is larger than the distance h2, a large amount of gas stays on the first surface 30A side, and a large space is formed before the terminal seal portion 36 is broken. That is, when the first sealing surface 36a on the first surface 30A side is broken, gas is discharged from the broken portion through a large space. Therefore, the pressure loss in the gas discharge channel is reduced, and the gas can be discharged quickly.

The seal strength of the exterior body 30 varies depending on the temperature and pressure at the time of press bonding, the state of the resin at the portion to be pressed, and the like. For example, when the sealing temperature of the first sealing surface 36a on the first surface 30A side is lower than the sealing temperature of the second sealing surface 36b on the second surface 30B side, the sealing strength of the first sealing surface 36a becomes lower than the sealing strength of the second sealing surface 36b.

When the exterior body 30 is an exterior film, the exterior body 30 (the first surface 30A) on the first sealing surface 36a side may be stretched more than the exterior body 30 (the second surface 30B) on the second sealing surface 36b side, in that case, the press bonding may be carried out at the same seal temperature. The resin constituting the exterior film is molecularly oriented when stretched. When the resin is molecularly oriented, heat of melting is required to eliminate the orientation state, and the resin is less likely to be welded. As a result, the seal strength of the first sealing surface 36a is lower than the seal strength of the second sealing surface 36b.

When the exterior film has a metal layer inside, the degree of stretching of the exterior film can be determined from the thickness of the metal layer. This is because, when the exterior film is stretched, the metal layer is stretched at the same ratio as the resin layer. Since the resin layer is welded, the thickness cannot be measured. Therefore, in the terminal seal portion 36, the thickness of the metal layer of the exterior body 30 on the first surface 30A side is preferably smaller than the thickness of the metal layer of the exterior body 30 on the second surface 30B side. When this configuration is satisfied, the first sealing surface 36a is more easily broken than the second sealing surface 36b.

The width w1 (see FIG. 3) of the terminal seal portion 36 is preferably 3.0 mm or more, more preferably 6.0 mm or more, and still more preferably 10.0 mm or more. If the width w1 of the terminal seal portion 36 is large, the broken width at the time of breaking can be widened. When the broken width is widened, the pressure loss at the broken point is reduced, and the gas can be quickly discharged.

Further, a length L1 (see FIG. 3) of the terminal seal portion 36 in the extending direction of the terminal 20 is preferably 1.0 mm or more and 3.0 mm or less, more preferably 1.2 mm or more and 2.5 mm or less. By setting the length L1 of the terminal seal portion 36 to be equal to or less than the upper limit, it is possible to prevent the terminal seal portion 36 that does not contribute to power generation from becoming too wide. Further, by making the length L1 of the terminal seal portion 36 equal to or larger than the lower limit value, it is possible to prevent moisture from entering the inside through the terminal seal portion 36.

The length L of the exterior body 30 in the x direction is preferably longer than the length W of the exterior body 30 in the y direction. When the exterior body 30 expands, the stress applied to the exterior body 30 is affected by the length in the expanding direction. When the length L of the exterior body 30 in the x direction is longer than the length W of the exterior body 30 in the y direction, the surface of the exterior body 30 in the x direction is easily broken. That is, the terminal seal portion 36 from which the terminal 20 extends is easily broken.

As shown in FIG. 2, the outermost surface of the power generation element 10 and at least one of the two terminals 20 may be connected by an insulation tape 40. In FIG. 2, the outermost surface of the power generation element 10 on the first surface 30A side of the exterior body 30 and the negative electrode terminal 22 are connected by the insulation tape 40. The insulation tape 40 presses the terminal 20 or the terminal of the power generation element 10 on the terminal 20 side. As a result, it is possible to suppress the flow of the gas discharged when the exterior body 30 is broken from being hindered by the separator 3 and the like constituting the power generation element 10. That is, the insulation tape serves as a flow path for the discharged gas. By controlling the flow of the discharged gas, the gas can be quickly discharged from the inside of the exterior body 30. The width of the insulation tape 40 may be substantially equal to the width of the terminal 20 or may be substantially equal to the width of the power generation element 10 in the y direction.

[Method of Manufacturing Lithium Ion Secondary Battery]

The method of manufacturing the lithium ion secondary battery according to the present embodiment can be manufactured by a known method except that the seal strength is set.

First, the positive electrode 1 and the negative electrode 2 are manufactured. The positive electrode 1 and the negative electrode 2 are different from each other only in the active material, and can be manufactured by the same manufacturing method.

A coating material is prepared by mixing the positive active material, binder and solvent to make a coating material. A conductive material may be further added, as needed. As the solvent, for example, water, N-methyl-2-pyrrolidone, N, N-dimethylformamide and the like can be used. The composition ratios of the positive electrode active material, the conductive material, and the binder are preferably 80% by mass to 90% by mass; 0.1% by mass to 10% by mass; and 0.1% by mass to 10% by mass, respectively. These mass ratios are adjusted so as to be 100 wt % in total.

The method of mixing these components constituting the coating material is not particularly limited, and the order of mixing is not particularly limited. The coating material is applied to the positive electrode current collector 1A. There is no particular limitation on the coating method, and a method usually used when an electrode is manufactured can be used. For example, there are a slit die coating method and a doctor blade method. The negative electrode is coated with a coating material on the negative electrode collector 2A in the same manner as the coating on the positive electrode collector 1A.

Next, the solvent in the coating material applied on the positive electrode current collector 1A and the negative electrode current collector 2A is removed. The removal method is not particularly limited, and a known method for removing a solvent can be applied. For example, the positive electrode current collector 1A and the negative electrode current collector 2A to which the coating material has been applied are dried in an atmosphere at 80° C. to 150° C. Then, the positive electrode 1 and the negative electrode 2 are obtained.

When the power generation element 10 is a laminate, the positive electrode 1, the negative electrode 2, and the separator 3 are laminated. When the power generation element 10 is a wound body, the positive electrode 1, the negative electrode 2, and the separator 3 are wound around one end side as an axis. In any case, the separator 3 is provided between the positive electrode 1 and the negative electrode 2. At this time, the outermost layer of the laminate or the wound body is preferably the positive electrode current collector 1A.

The power generation element 10 is sealed in the exterior body 30. The nonaqueous electrolyte may be injected into the exterior body 30 or the power generation element 10 may be impregnated with the nonaqueous electrolyte.

Finally, the outer periphery of the exterior body 30 is sealed. Sealing is performed by lamination using heat or the like. The seal strength of each part on the outer periphery of the exterior body 30 can be changed according to the lamination conditions. As a method of changing the seal strength, for example, as a first method, there is a method of changing a heating temperature or a heating time of a portion to be sealed. As a method of changing the seal strength, for example, as a second method, there is a method of changing the seal strength according to the state of the resin at the portion to be sealed. The state of the resin in the portion to be sealed varies depending on the degree of stretching of the film. In a greatly stretched portion, the thermal conductivity decreases and the seal strength decreases. When the second method is used, the reproducibility of the seal strength is higher than when the first method is used. The degree of stretching of the film can be changed according to the magnification condition when stretching the region of the laminate film including the part, for which the degree of stretching is desired to be changed, with a tenter or the like before shaping the laminate as an exterior body, and the degree of stretching of the film can be changed according to the pressing pressure condition when molding the recess in the laminate film with a mold.

As described above, according to the present embodiment of the lithium ion secondary battery, the gas accumulated in the exterior body 30 can be discharged before the power generation element 10 generates abnormal heat. Further, the portion which tends to accumulate in the exterior body 30 is broken, so that the gas is discharged quickly and the power generation element 10 can be cooled efficiently.

Although the present embodiment has been described in detail with reference to the drawings, each configuration and combination thereof in each embodiment are examples, and addition, omission, substitution, and other modifications of configurations are possible within the scope that does not deviate from the purport of the present invention.

### EXAMPLES

### Example 1

First, a positive electrode was produced by applying a positive electrode active material layers on both sides of a positive electrode current collector made of aluminum foil. The positive electrode active material layer was composed of 94 parts by mass of LiCoO₂ (active material), 2 parts by mass of carbon (conductive material), and 4 parts by mass of polyvinylidene fluoride (PVDF, binder).

Similarly, a negative electrode was produced by applying negative electrode active material layers on both sides of a negative electrode current collector made of copper foil. The negative electrode active material layer was composed of 95 parts by mass of graphite (active material), 1 part by mass of carbon (conductive material), 1.5 parts by mass of styrene butadiene rubber (SBR, binder), and 2.5 parts by mass of sodium carboxymethylcellulose (CMC, binder).

A porous polyethylene stretched membrane was prepared as a separator. Then, the positive electrode, the negative electrode, and the separator were wound up to produce a power generation element (wound body).

A lithium ion secondary battery (Nonaqueous Electrolyte secondary battery) was produced by housing the produced power generation element in the exterior body and injecting 6 g nonaqueous electrolyte. The cell size of the lithium ion secondary battery was 4.7 mm in thickness, 74.5 mm in width, 99.8 mm in length, and the cell capacity was 4.22 mAh.

Aluminum laminate film was used for the exterior. The ratio of the distance h1 between the first surface and the terminal seal portion (distance between the outer surface of the first surface and the outer surface of the exterior body covering the terminal seal portion) to the distance h2 between the second surface and the terminal seal portion (distance between the outer surface of the second surface and the outer surface of the exterior body covering the terminal seal portion) was 3:2. The distance between the inner end of the terminal seal portion and the power generation element was 1.5 mm. The nonaqueous electrolyte was prepared by adding 1.0 M (mol/L) of LiPF₆ as a lithium salt into a solvent containing ethylene carbonate (EC), propylene carbonate (PC), and diethyl carbonate (DEC) in a volume ratio of 35:35:30. And, the sealing of the exterior body was carried out by changing the sealing temperature for each seal position.

Two lithium ion secondary batteries were manufactured at the same level. One was used for measuring the peel strength, and the other was used for confirming the maximum temperature reached by the lithium ion secondary battery.

The peel strength was measured at each of the top seal, side seal, and terminal seal portions of the manufactured lithium ion secondary battery. The peel strength of the side seal portion was measured at each of the first edge and the second edge facing the first edge. The first edge is referred to as a first side seal, and the second edge is referred to as a second side seal. The peel strength of the terminal seal portion was measured at four points: the first sealing surface of the positive electrode terminal, the second sealing surface of the positive electrode terminal, the first sealing surface of the negative electrode terminal, and the second sealing surface of the negative electrode terminal. The measurement of the peel strength was performed according to the procedure described above. The results were shown in Table 1.

The maximum temperature of the lithium ion secondary battery was measured by an overcharge test. In the overcharge test, a battery with a battery capacity (SOC) of 100% at a room temperature was charged at a current of 0.7 C and held at 10 V for 90 minutes. The temperature was measured by attaching a thermocouple to the terminal. As a result, the maximum temperature of the lithium ion secondary battery of Example 1 was 174° C., which was lower than the temperature (about 200° C.) at which the risk of causing an abnormal reaction increased. The results were shown in Table 2.

### Examples 2 to 4

In Examples 2 to 4, the distance d1 between the inner terminal of the terminal seal portion and the power generation element was changed. Other conditions were the same as in Example 1. In Example 2, the distance d1 was set to 1.0 mm. In Example 3, the distance d1 was set to 1.3 mm. In Example 4, the distance d1 was set to 15 mm. The results of each measurement are shown in Table 1 and Table 2.

### Example 5

In Example 5, the insulation tape 40 was provided between the outermost surface of the power generation element and one of the two terminals (negative electrode terminal). Other conditions were the same as in Example 1. The measurement results are shown in Tables 1 and 2.

### Example 6

In Example 6, the seal strength of the first sealing surface of the negative electrode was made weaker than that of the second sealing surface. Other conditions were the same as in Example 1. The measurement results are shown in Tables 1 and 2.

### Example 7

In Example 7, the ratio of the distance h1 between the first surface and the terminal seal portion to the distance h2 between the second surface and the terminal seal portion was 5:2. Other conditions were the same as in Example 6. The measurement results are shown in Tables 1 and 2.

### Example 8

In Example 8, the seal strength of the terminal seal portion and the top seal portion was changed. Other conditions were the same as in Example 7. The measurement results are shown in Tables 1 and 2.

### Examples 9 and 10

In Examples 9 and 10, the cell size of the power generation element was changed. Other conditions were the same as in Example 8. In Example 9, the cell size was 2.6 mm in thickness, 72.4 mm in width, and 49.8 mm in length, and the cell capacity was 1.1 mAh. In Example 10, the cell size was 4.7 mm in thickness, 74.6 mm in width, and 179.7 mm in length, and the cell capacity was 7.5 mAh. The measurement results are shown in Tables 1 and 2.

### Example 11

In Example 11, the sealing method for sealing the exterior body was changed. Other conditions were the same as in Example 8. In Example 8, the seal strength was adjusted by the sealing temperature. In Example 11, the seal strength was adjusted by the degree of stretching of the film. The degree of stretching of the film can be confirmed from the thickness ratio of the metal layer (Al layer) of the exterior body. In Table 2, the thickness of the Al layer of the exterior body on the first sealing surface side with respect to the thickness of the Al layer of the exterior body on the second sealing surface side is expressed as “ratio of Al thickness of the exterior body”. The measurement results are shown in Tables 1 and 2. The measurement of the “ratio of the Al thickness of the exterior body” was performed at an arbitrary point of the side formed by the top seal portion and the terminal seal portion.

### Examples 12 to 18

In Examples 12 to 18, the solvent of the electrolyte contained in the power generation element was changed. Other conditions were the same as in Example 11. The measurement results are shown in Tables 1 and 2.

### Example 19

Example 19 was different from Example 1 in that both surfaces of the separator were coated with an inorganic particle layer. Other conditions were the same as in Example 1. The measurement results are shown in Tables 1 and 2.

### Comparative Example 1

Comparative Example 1 was different from Example 7 in that the seal strength of the terminal seal portion was changed. Other conditions were the same as in Example 7. In Comparative Example 1, the minimum value of the seal strength of the terminal seal portion was 4.9 N/mm. The measurement results are shown in Tables 1 and 2.

### Comparative Example 2

Comparative Example 2 was different from Example 9 in that the seal strength of the terminal seal portion and the top seal portion was changed. Other conditions were the same as in Example 9. In Comparative Example 1, the minimum value of the seal strength of the terminal seal portion was 4.9 N/mm. The measurement results are shown in Tables 1 and 2.

### Comparative Example 3

Comparative Example 3 was different from Example 10 in that the seal strength of the terminal seal portion and the top seal portion was changed. Other conditions were the same as in Example 10. In Comparative Example 1, the minimum value of the seal strength of the terminal seal portion was 4.9 N/mm. The measurement results are shown in Tables 1 and 2.

### Comparative Example 4

Comparative Example 4 was different from Example 18 in that the seal strength of the terminal seal portion and the top seal portion was changed. Other conditions were the same as in Example 18. In Comparative Example 1, the minimum value of the seal strength of the terminal seal portion was 4.9 N/mm. The measurement results are shown in Tables 1 and 2.

TABLE 1

| | Seal strength | | | | | | |
|---|---|---|---|---|---|---|---|
| | Terminal seal portion | | | | | | |
| | | Positive | | | | | |
| | Positive | electrode | | Negative | | Side seal portion | |
| | electrode | (Second | | electrode | | First | Second |
| | (First | seal | Negative | (Second | | Side | Side |
| | seal | surface) | electrode | seal | | seal | seal |
| | surface) | surface) | (First seal | surface) | Top seal | portion | portion |
| | (N/mm) | (N/mm) | (N/mm) | (N/mm) | portion | (N/mm) | (N/mm) |
| Example 1 | 5.1 | 5.1 | 5.1 | 4.5 | 6.0 | 7.5 | 7.0 |
| Example 2 | 5.1 | 5.1 | 5.1 | 4.5 | 6.0 | 7.5 | 7.0 |
| Example 3 | 5.1 | 5.1 | 5.1 | 4.5 | 6.0 | 7.5 | 7.0 |
| Example 4 | 5.1 | 5.1 | 5.1 | 4.5 | 6.0 | 7.5 | 7.0 |
| Example 5 | 5.1 | 5.1 | 5.1 | 4.5 | 6.0 | 7.5 | 7.0 |
| Example 6 | 5.1 | 5.1 | 4.5 | 5.1 | 6.0 | 7.5 | 7.0 |
| Example 7 | 5.1 | 5.1 | 4.5 | 5.1 | 6.0 | 7.5 | 7.0 |
| Example 8 | 3.6 | 3.6 | 3.0 | 3.6 | 4.5 | 7.5 | 7.0 |
| Example 9 | 3.6 | 3.6 | 3.0 | 3.6 | 4.5 | 7.5 | 7.0 |
| Example 10 | 3.6 | 3.6 | 3.0 | 3.6 | 4.5 | 7.5 | 7.0 |
| Example 11 | 3.6 | 3.6 | 3.0 | 3.6 | 4.5 | 7.5 | 7.0 |
| Example 12 | 3.6 | 3.6 | 3.0 | 3.6 | 4.5 | 7.5 | 7.0 |
| Example 13 | 3.6 | 3.6 | 3.0 | 3.6 | 4.5 | 7.5 | 7.0 |
| Example 14 | 3.6 | 3.6 | 3.0 | 3.6 | 4.5 | 7.5 | 7.0 |
| Example 15 | 3.6 | 3.6 | 3.0 | 3.6 | 4.5 | 7.5 | 7.0 |
| Example 16 | 3.6 | 3.6 | 3.0 | 3.6 | 4.5 | 7.5 | 7.0 |
| Example 17 | 3.6 | 3.6 | 3.0 | 3.6 | 4.5 | 7.5 | 7.0 |
| Example 18 | 3.6 | 3.6 | 3.0 | 3.6 | 4.5 | 7.5 | 7.0 |
| Example 19 | 5.1 | 5.1 | 5.1 | 4.5 | 6.0 | 7.5 | 7.0 |
| Comparative | 5.5 | 5.5 | 5.5 | 4.9 | 6.0 | 7.5 | 7.0 |
| Example 1 | | | | | | | |
| Comparative | 5.5 | 5.5 | 5.5 | 4.9 | 6.0 | 7.5 | 7.0 |
| Example 2 | | | | | | | |
| Comparative | 5.5 | 5.5 | 5.5 | 4.9 | 6.0 | 7.5 | 7.0 |
| Example 3 | | | | | | | |
| Comparative | 5.5 | 5.5 | 5.5 | 4.9 | 6.0 | 7.5 | 7.0 |
| Example 4 | | | | | | | |

TABLE 2

| | Ratio of Al | | | | Inorganic particle | | Cell | Maximum |
|---|---|---|---|---|---|---|---|---|
| | thickness of | dl * | | Insulation | layer (separator) | | capacity | achieved Tab |
| | exterior body | (mm) | hi:h2 ** | tape | (μm) | Solvent composition | (mAh) | temperature (° C.) |
| Example 1 | 1.00 | 1.5 | 3:2 | No | 0 | EC/PC/DEC = 35/35/30 | 4.2 | 174 |
| Example 2 | 1.00 | 1.0 | 3:2 | No | 0 | EC/PC/DEC = 35/35/30 | 4.2 | 187 |
| Example 3 | 1.00 | 1.3 | 3:2 | No | 0 | EC/PC/DEC = 35/35/30 | 4.2 | 176 |
| Example 4 | 1.00 | 15 | 3:2 | No | 0 | EC/PC/DEC = 35/35/30 | 4.2 | 172 |
| Example 5 | 1.00 | 1.5 | 3:2 | Yes | 0 | EC/PC/DEC = 35/35/30 | 4.2 | 166 |
| Example 6 | 1.00 | 1.5 | 3:2 | No | 0 | EC/PC/DEC = 35/35/30 | 4.2 | 157 |
| Example 7 | 1.00 | 1.5 | 5:2 | No | 0 | EC/PC/DEC = 35/35/30 | 4.2 | 151 |
| Example 8 | 1.00 | 1.5 | 5:2 | No | 0 | EC/PC/DEC = 35/35/30 | 4.2 | 133 |
| Example 9 | 1.00 | 1.5 | 5:2 | No | 0 | EC/PC/DEC = 35/35/30 | 1.1 | 104 |
| Example 10 | 1.00 | 1.5 | 5:2 | No | 0 | EC/PC/DEC = 35/35/30 | 7.5 | 167 |
| Example 11 | 0.92 | 1.5 | 5:2 | No | 0 | EC/PC/DEC = 35/35/30 | 4.2 | 132 |
| Example 12 | 0.92 | 1.5 | 5:2 | No | 0 | EC/PC/DEC = 25/25/50 | 4.2 | 121 |
| Example 13 | 0.92 | 1.5 | 5:2 | No | 0 | EC/PC/DEC = 7.5/7.5/85 | 4.2 | 115 |
| Example 14 | 0.92 | 1.5 | 5:2 | No | 0 | EC/PC/PrP = 25/25/50 | 4.2 | 120 |
| Example 15 | 0.92 | 1.5 | 5:2 | No | 0 | EC/PC/EMC = 35/30/35 | 4.2 | 118 |
| Example 16 | 0.92 | 1.5 | 5:2 | No | 0 | EC/PC/EMC = 7.5/7.5/85 | 4.2 | 109 |
| Example 17 | 0.92 | 1.5 | 5:2 | No | 0 | EC/PC/EA = 32.5/32.5/35 | 4.2 | 114 |
| Example 18 | 0.92 | 1.5 | 5:2 | No | 0 | EC/PC/DEC/EMC = 20/20/20/40 | 4.2 | 112 |
| Example 19 | 1.00 | 1.5 | 3:2 | No | 1.5 | EC/PC/DEC = 35/35/30 | 4.2 | 162 |
| Comparative | 1.00 | 1.5 | 5:2 | No | 0 | EC/PC/DEC = 35/35/30 | 4.2 | >200 |
| Example 1 | | | | | | | | |
| Comparative | 1.00 | 1.5 | 5:2 | No | 0 | EC/PC/DEC = 35/35/30 | 1.1 | 181 |
| Example 2 | | | | | | | | |
| Comparative | 1.00 | 1.5 | 5:2 | No | 0 | EC/PC/DEC = 35/35/30 | 7.5 | >200 |
| Example 3 | | | | | | | | |
| Comparative | 0.92 | 1.5 | 5:2 | No | 0 | EC/PC/DEC/EMC = 20/20/20/40 | 4.2 | >200 |
| Example 4 | | | | | | | | |

* “d1”: Distance between terminal and power generation element
** “hl:h2”: “Distance between the first surface and terminal seal portion”:“Distance between the second surface and terminal seal portion

In Examples 1 to 19 and Comparative Examples 1 to 4, the portions where the exterior body was broken were all terminal seal portions. In all of Examples 1 to 19, the maximum temperature did not reach the temperature at which the risk of causing an abnormal reaction of the lithium ion secondary battery increased.

### REFERENCE SIGNS LIST

1: Positive electrode
1A: Positive electrode current collector
1B: Positive electrode active material layer
2: Negative electrode
2A: Negative electrode current collector
2B: Negative electrode active material layer
3: Separator
10: Power generation element
20: Terminal
21: Positive electrode terminal
22: Negative electrode terminal
30: Exterior body
30A: First surface
30Aa: Outer surface of the first surface
30 Ab: Outer surface on the first surface side of the exterior body covering the terminal seal portion
30B: Second surface
30Ba: Outer surface of the second surface
30Bb: Outer surface on the second surface side of the exterior body covering the terminal seal portion
36a: First sealing surface
36b: Second sealing surface
37: Inner end portion
40: Insulation tape
100: Nonaqueous electrolyte secondary battery
K: Housing space

1. A nonaqueous electrolyte secondary battery, comprising:
a power generation element in which a positive electrode and a negative electrode exchange ions via an electrolyte;
two terminals connected to the positive electrode and the negative electrode, respectively; and
an exterior body which covers the power generation element and the two terminals so that one end of each of the two terminals extends outward, and which has a sealed outer periphery,
wherein a seal strength of the outer periphery of the exterior body is the weakest at a terminal sealing portion sandwiching the two terminals; and
at least one surface of the terminal seal portion has a seal strength of 4.5 N/mm or less.

2. The nonaqueous electrolyte secondary battery according to claim 1, wherein a distance between an inner end portion of the terminal seal portion and the power generation element is 1.2 mm or more and 15 mm or less.

3. The nonaqueous electrolyte secondary battery according to claim 1, further comprising an insulation tape connecting at least one of the two terminals and an outermost surface of the power generation element.

4. The nonaqueous electrolyte secondary battery according to claim 1, wherein the exterior body has a first surface and a second surface that intersect with a line perpendicular to a surface extending from the sealing surface, and
a seal strength of the terminal seal portion on the first surface side is the weakest among seal strengths of the outer periphery of the exterior body.

5. The nonaqueous electrolyte secondary battery according to claim 4, wherein the exterior body is formed by sealing exterior films each having a metal layer inside, and
a thickness of the metal layer in the terminal seal portion on the first surface side is smaller than a thickness of the metal layer in the terminal seal portion on the second surface side.

6. The nonaqueous electrolyte secondary battery according to claim 1, wherein the electrolyte contained in the power generation element comprises a salt and a nonaqueous solvent, and
the nonaqueous solvent comprises 50% or more by mass and 85% or less by mass of a low-boiling solvent having a boiling point of 130° C. or less.

7. The nonaqueous electrolyte secondary battery according to claim 1, wherein the electrolyte contained in the power generation element comprises a salt and a nonaqueous solvent, and
the nonaqueous solvent comprises 35% or more by mass and 85% or less by mass of a low-boiling solvent having a boiling point of 110° C. or less.
